(19) United States
(12) Patent Application Publication
(10) Pub. No.: US 2012/0287622 A1
(43) Pub. Date: Nov. 15, 2012

(54) ILLUMINATION DEVICE AND DISPLAY DEVICE

(75) Inventor: Shinnosuke Nozawa, Osaka-shi (JP)

(73) Assignee: SHARP KABUSHIKI KAISHA, Osaka-shi, Osaka (JP)

(21) Appl. No.: 13/511,037

(22) PCT Filed: Sep. 28, 2010
(86) PCT No.: PCT/JP2010/066776

§ 371 Date: May 21, 2012

(30) Foreign Application Priority Data
Dec. 2, 2009 (JP) 2009-274392

(51) Int. Cl. F21V 9/00; F21V 11/00; F21V 21/00

(52) U.S. Cl. 362/231; 362/382; 362/249.02; 362/311.01

(57) ABSTRACT

The peripheral edges of a mounting substrate (11) are wave-shaped with undulations, the peripheral edges having a relationship such that protrusions (11T) and depressions (11B) constituting undulations on opposing peripheral edges mesh together. The spacing (WT) between the protrusions (11T) on the peripheral edges and the spacing (WB) between the depressions (11B) on the peripheral edges are then constant, especially on the mounting substrate (11).

### TECHNICAL FIELD

The present invention relates to illumination devices for supplying light to a display panel in television monitors, digital signs, and the like, and also relates to display devices incorporating such an illumination device and a display panel.

### BACKGROUND ART

A liquid crystal display device (display device) that incorporates a non-luminous liquid crystal display panel (display panel) typically also incorporates a backlight unit (illumination device) for supplying light to the liquid crystal display panel. The backlight unit can employ one of many different types of light source. For example, the backlight unit disclosed in Patent Document 1 listed below employs an LED (light emitting diode) as a light source.

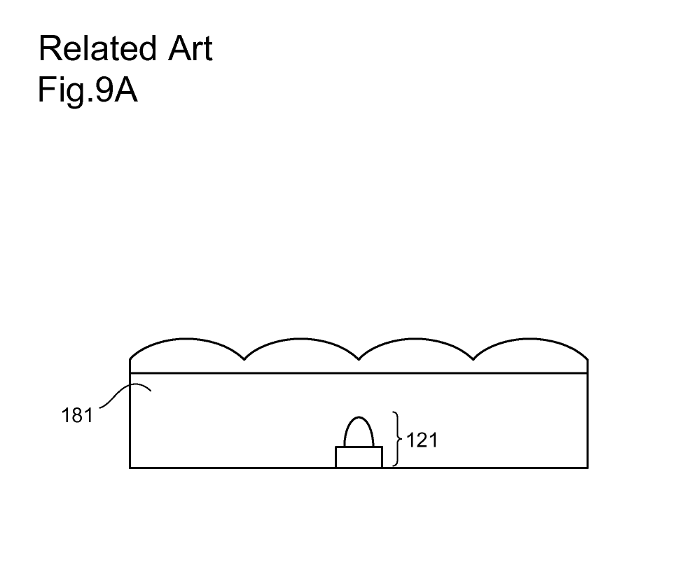

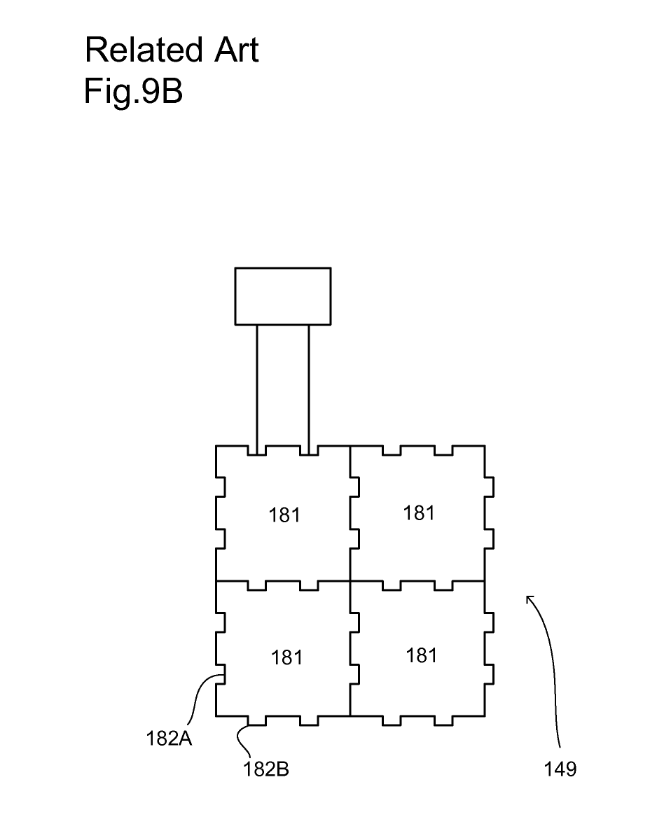

As shown in a sectional view in FIG. 9, in the backlight unit disclosed in Patent Document 1, a planar light emitting member 181 has an LED 121 housed in it. As shown in a plan view in FIG. 9B, the planar light emitting member 181 has edges composed of dents 182A and juts 182B. Between two planar light emitting members 181 placed next to each other, the dents 182A and juts 182B fit into each other, and this makes the planar light emitting members 181 less likely to be displaced along each other.

### LIST OF CITATIONS

### Patent Literature

Patent Document 1: JP-A-2009-176899

### SUMMARY OF INVENTION

### Technical Problem

In the backlight unit 149 disclosed in Patent Document 1, arranging planar light emitting members 181 in close contact with one another results in giving them as a whole a square or rectangular shape. This makes those planar light emitting members 181 difficult to use in backlight units of other shapes.

The present invention has been made to overcome the inconvenience mentioned above, and aims to provide illumination devices and the like that incorporate a light source mounting member (for example, a mounting board for mounting an LED on it) that is less likely to be displaced and that can be assembled into various shapes.

### Solution to Problem

To achieve the above object, according to the present invention, an illumination device includes a light source and a plurality of mounting boards on which the light source is arranged. In this illumination device, the plurality of mounting boards are arranged in close contact with one another, the mounting boards have edges that are wavy as by being undulated (wave-shaped) or serrated (saw-tooth-shaped), abutting ones of the edges have wavy contours composed of protrusions and recessions that are in a meshing relationship, and the protrusions at the edges occur at constant intervals and the recessions at the edges occur at constant intervals.

With this design, when the mounting boards are arranged in close contact with one another, their edges mesh with each other. This makes the mounting boards less likely to be displaced. In addition, even when the edges of adjoining mounting boards do not completely coincide but are displaced along each other, they make close contact with each other. Thus, arranging a plurality of mounting boards in close contact with one another results in giving them as a whole a shape other than rectangular. The mounting boards are then easy to cope with backlight units of various shapes.

Preferably, the mounting boards are, at the edges thereof, fitted with connectors each including a positive terminal that electrically conducts to the positive electrode of the light source and a negative terminal that electrically conducts to the negative electrode of the light source, and between the connectors of adjoining ones of the mounting boards, the terminals of each of the same polarities electrically conduct to each other.

With this design, the mounting boards arranged in close contact with one another achieve electrical conduction via their respective connectors.

The light source may be, for example, a light emitting element. The light emitting element may include a plurality of light emitting elements that emit red, green, and blue light respectively, or a plurality of light emitting elements that emit white light.

Preferably, the illumination device further includes a power adjustor which adjusts the amount of electric power supplied to the light source.

Preferably, the illumination device further includes a diffusive member which diffuses light from the light source, and/or a luminance enhancing member which enhances luminance while transmitting light from the light source.

The present invention encompasses display devices that include an illumination device as described above in combination with a display panel (for example, a liquid crystal display panel) that receives light from the illumination device.

### Advantageous Effects of the Invention

According to the present invention, mounting boards are less likely to be disclosed and in addition can be assembled into various shapes.

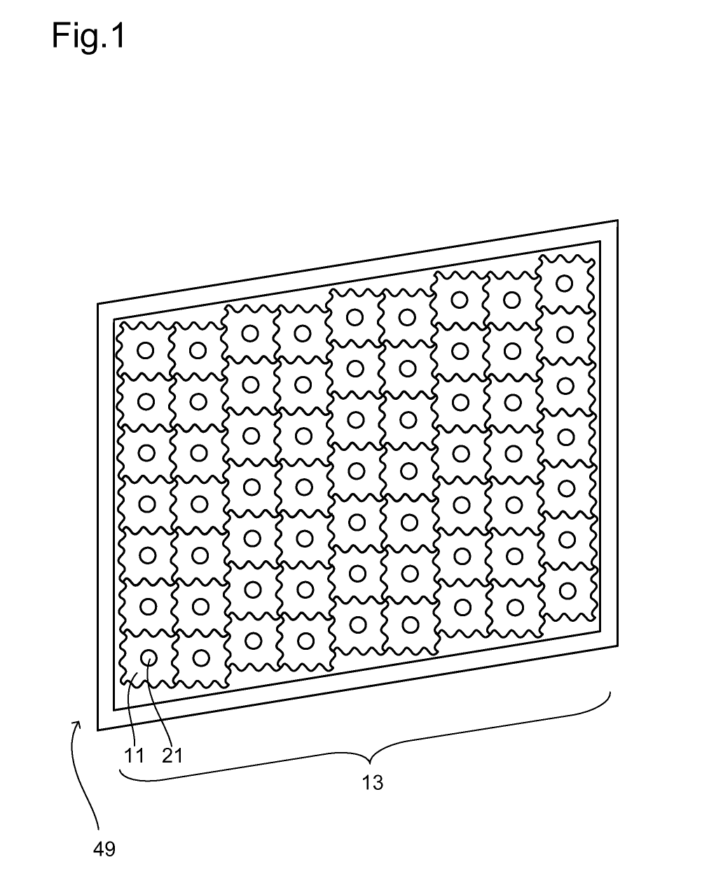

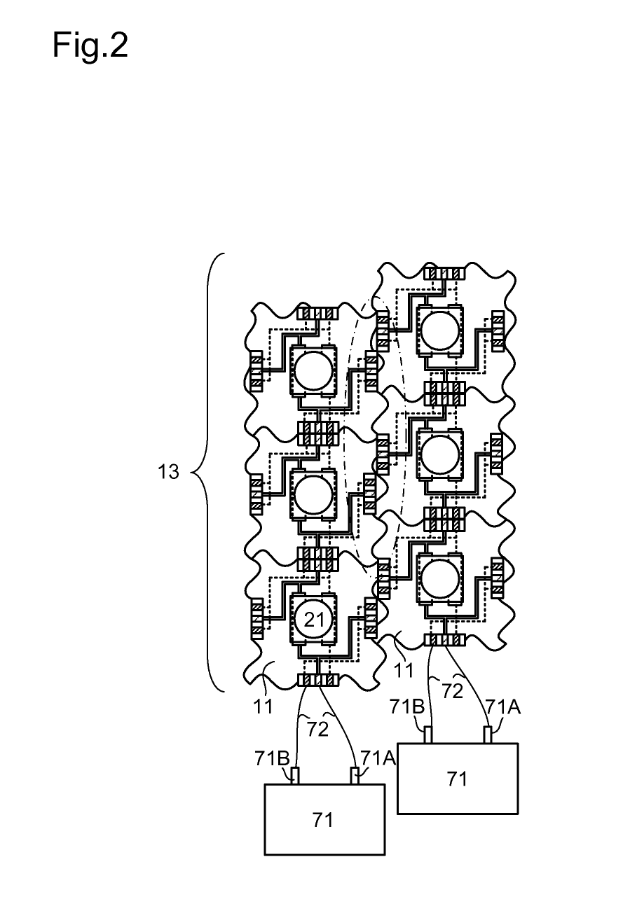

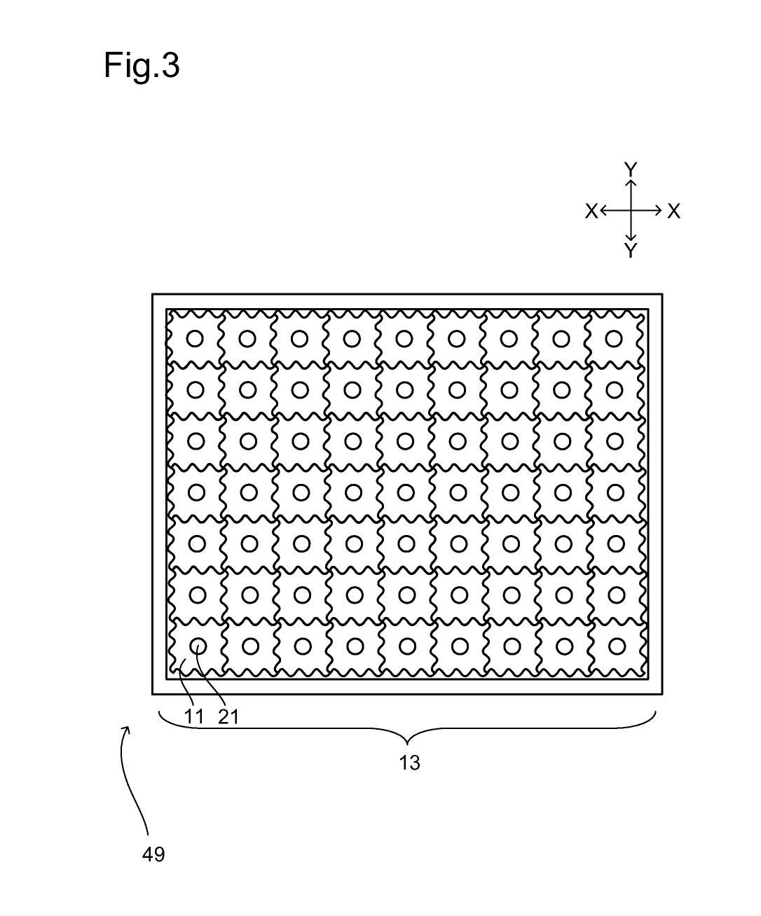

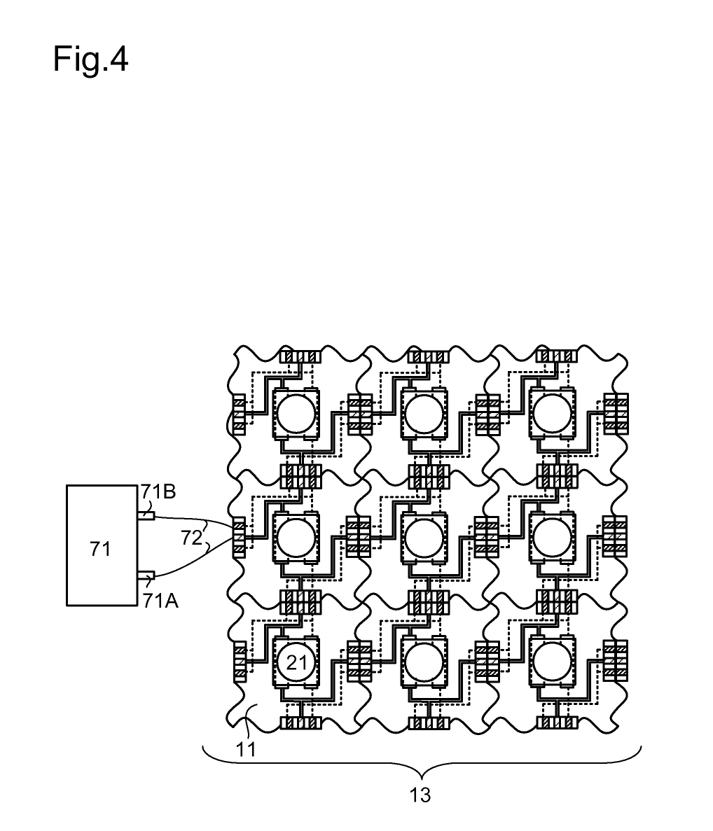

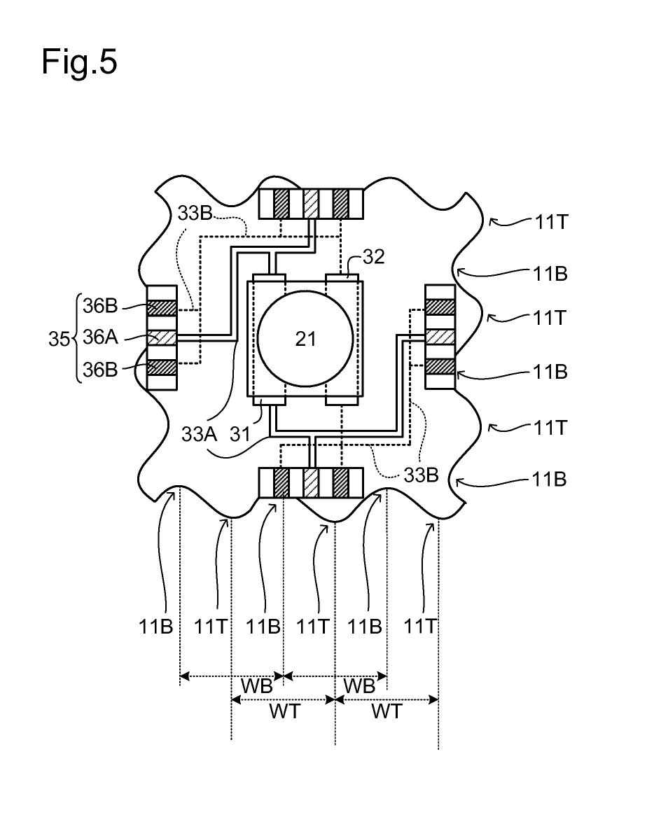

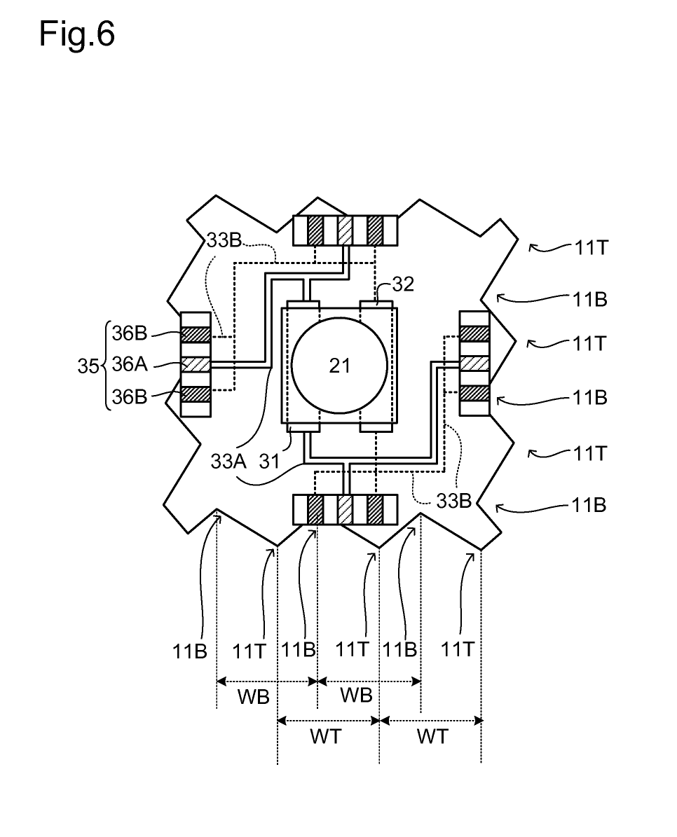

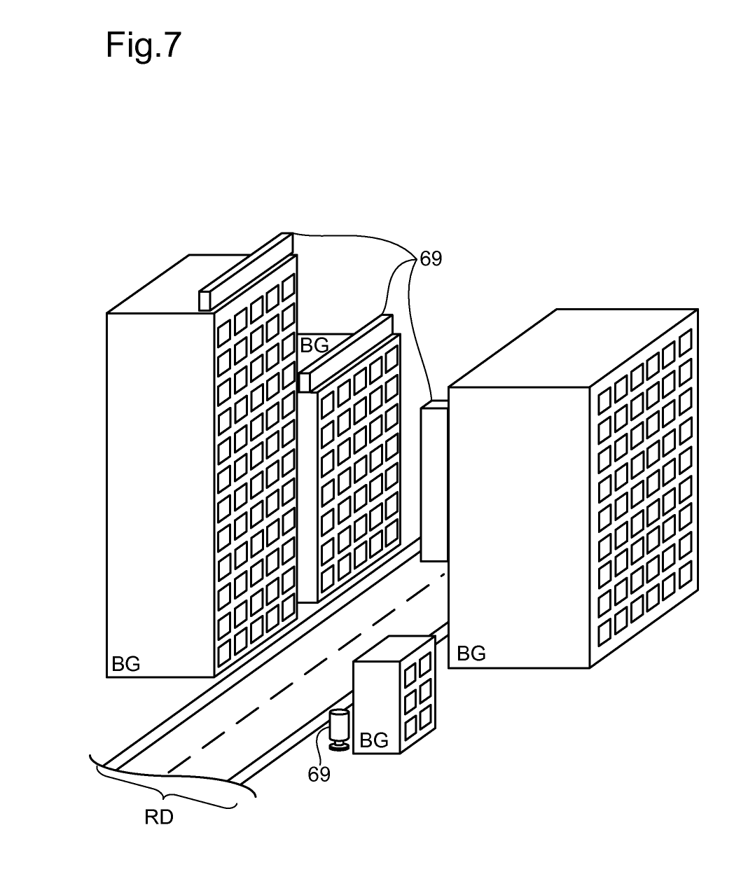

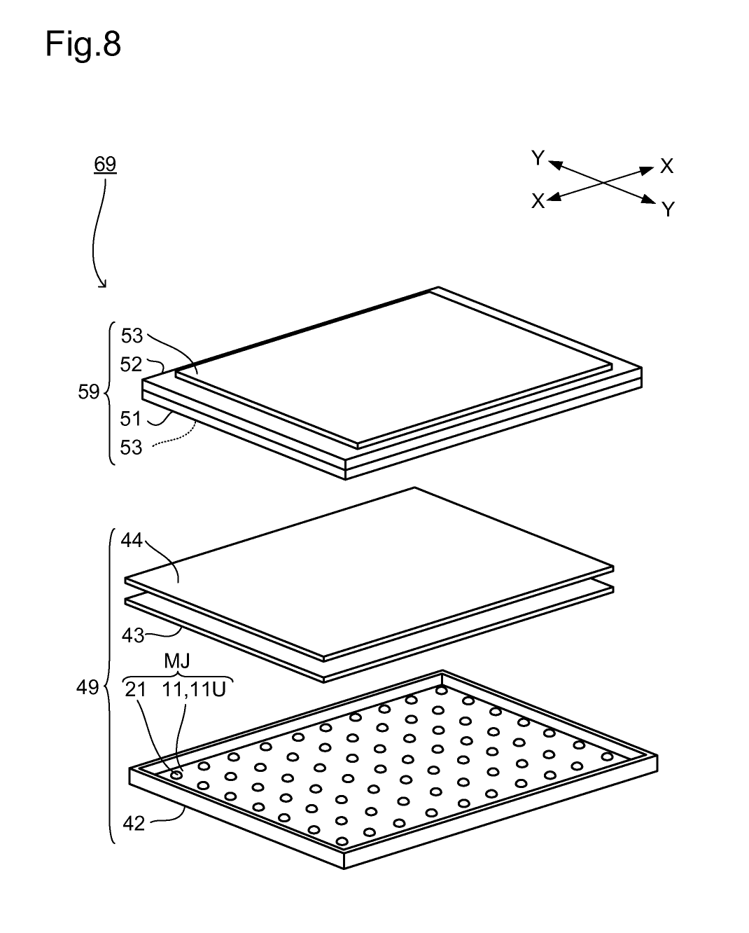

### BRIEF DESCRIPTION OF DRAWINGS

[FIG. 1] is a plan view showing mounting boards in a backlight unit;

[FIG. 2] is an enlarged plan view of mounting boards;

[FIG. 3] is a plan view showing mounting boards in a backlight unit;

[FIG. 4] is an enlarged plan view of mounting boards;

[FIG. 5] is a plan view of a mounting board;

[FIG. 6] is a plan view of a mounting board;

[FIG. 7] is a perspective view showing display devices used in digital signage;

[FIG. 8] is an exploded perspective view of (an outline of) a liquid crystal display device as a display device;

[FIG. 9A] is a sectional view of a planar light emitting member incorporating an LED as used in a conventional backlight unit; and

[FIG. 9B] is a plan view showing a plurality of planar light emitting members arranged side by side.

### DESCRIPTION OF EMBODIMENTS

An embodiment of the invention will be described below with reference to the accompanying drawings. For convenience' sake, reference signs and the like are occasionally omitted, in which case other relevant drawings are to be referred to.

FIG. 7 is a perspective view showing an example of digital signage. As shown in FIG. 7, display devices 69 mounted on buildings BG beside roads RD, and display devices 69 placed in front of buildings BG, serve as digital signs.

In a case where such a display device 69 is, for example, a liquid crystal display device, as shown in a schematic diagram in FIG. 8, it includes a liquid crystal display panel (display panel) 59 and a backlight unit (illumination device) 49 which supplies light to the liquid crystal display panel 59.

The liquid crystal display panel 59 is composed of an active matrix substrate 51, which includes switching devices such as TFTs (thin-film transistors), and a counter substrate 52, which is disposed opposite the active matrix substrate 51, bonded together with a sealing member (not shown). The gap between the two substrates 51 and 52 is filled with liquid crystal (not shown).

The active matrix substrate 51 is, on its light entrance side, fitted with a polarizing film 53, and the counter substrate 52 is, on its light exit side, fitted with a polarizing film 53. Structured as described above, the liquid crystal display panel 59 displays images by utilizing variation in transmittance resulting from inclination of liquid crystal molecules.

Next, the backlight unit 49, which is located immediately behind the liquid crystal display panel 59, will be described. The backlight unit 49 includes LED modules (light emitting modules) MJ, a diffusive plate 43, and a luminance enhancing film 44 (a casing in which these are housed is referred to as a backlight chassis 42).

The LED modules MJ include LEDs (light emitting diodes) 21, which are light emitting elements acting as point light sources, and a mounting board 11, on which those LEDs 21 are mounted. These will be described in detail later.

The diffusive plate (diffusive member) 43 is a sheet-form optical member that is laid over the board surface 11U (the mounting surface 11U of the mounting board 11) on which the LEDs 21 are mounted all over. The diffusive plate 43 receives and diffuses the light emanating from the LED modules MJ. That is, the diffusive plate 43 diffuses the planar light formed by the plurality of LED modules MJ to illuminate the entire area over the liquid crystal display panel 59.

The luminance enhancing film (luminance enhancing member) 44 is, for example, an optical member that has a prism-like shape on its surface to alter the radiating properties of light. The luminance enhancing film 44 is located to cover the diffusive plate 43. Thus, the luminance enhancing film 44 condenses the light emanating from the diffusive plate 43 to increase luminance.

Structured as described above, the backlight unit 49 passes the planar light (backlight) formed by the LED modules MJ through the plurality of optical members 43 and 44 and supplies it to the liquid crystal display panel 59. Receiving the backlight from the backlight unit 49, the non-luminous liquid crystal display panel 59 provides improved display performance.

Now, the LED modules MJ will be described in detail with reference to FIGS. 3 and 4. FIG. 3 is a plan view that mainly shows the LED modules MJ of the backlight unit 49, and FIG. 4 is an enlarged view of part of FIG. 3. As shown in these diagrams, the backlight unit 49 has LEDs 21 all over (in FIG. 1, for convenience' sake, connectors 35 etc. which will be described later, are omitted).

The LEDs 21 are mounted on mounting boards 11. As shown in FIG. 5, the mounting boards 11 have edges that are wavy as by being undulated (such as sinusoidal) edges. Each edge of a mounting board 11 is in a meshing relationship with the edge opposite it. That is, between mounting boards 11 having abutting edges, wavy protrusions 11T in the undulated contour at one edge and recessions 11B in the undulated contour at the other edge are opposite each other so that the protrusions 11T and the recessions 11B can make close contact with each other (the protrusions 11T and the recessions 11B have oppositely undulated shapes; that is, the protrusions 11T, when made to protrude in the opposite direction, describe the recessions 11B, and vice versa).

With this design, as shown in FIG. 3, a plurality of mounting boards 11 of an identical shape, all with undulated edges, make close contact with each other in a lattice-form (matrix-form) arrangement. An assembly of a plurality of mounting boards 11 so put together in close contact with each other is referred to as a mounting board unit 13 (there is no particular limitation on how the mounting boards 11 are connected together; they may be bonded together with adhesive, or may be fixed together with a fixing member). When at least one mounting board 11 tends to be moved in a plurality of directions that cross each other on the board surface (for example, in the two directions in which the mounting boards 11 are arranged (of those directions, one is referred to as the X direction and the other is referred to as the Y direction)), it is prevented from moving by making contact with another, adjoining mounting board 11.

That is, that at least one mounting board 11 is prevented from moving by making contact with the other mounting boards 11 arranged in the direction crossing the direction in which it tends to be moved. Thus, on the overall mounting board 11, the mounting boards 11 are less likely to be displaced in directions across the board surface (in any direction across it).

In general, in a design where a plurality of square mounting boards are put together in close contact with one another to form an overall mounting board, when one mounting board tends to move in the two mutually perpendicular directions in which the mounting boards are arranged side by side, not only that one mounting board but also other mounting boards adjoining it move together.

By contrast, in a design as shown in FIG. 1 where a plurality of mounting boards 11 with undulated edges are put together to form an overall mounting board 11 as a whole, even when one mounting board 11 tends to move in two mutually perpendicular directions, it is prevented from moving by other mounting boards 11 engaging with that one mounting board 11. Thus, it does not occur that a plurality of mounting board 11 move together relative to the other mounting boards 11. That is, in the backlight unit 49 so structured, the mounting boards 11 are arranged stably with no possible displacement relative to each other (thus, the mounting board unit 13 as a whole has increased strength).

The arrangement of the mounting boards 11, however, is not limited to a matrix-form arrangement as shown in FIGS. 3 and 4. As described above, each mounting board 11 has wavy, specifically undulated, edges, and the protrusions 11T and recessions 11B in the wavy contours at abutting edges are in a meshing relationship. Here, special note should be taken of the fact that, as shown in FIG. 5, at the edges of the mounting boards 11, the protrusions 11T occur at constant intervals WT and the recessions 11B occur at constant intervals WB (the intervals WT and WB are equal).

With this design, when a plurality of mounting boards 11 are arranged side by side in two mutually perpendicular directions in a matrix-form arrangement as shown in FIGS. 3 and 4, adjoining mounting boards 11 make close contact with one another, and consequently their edges mesh together securely (in other words, one edge of a mounting board 11 necessarily abuts one other mounting board 11). The mounting boards 11 can make close contact with one another in different ways, as shown in FIGS. 1 and 2 (FIG. 2 being an enlarged view of part of FIG. 1).

Specifically, in a case where the undulated contour at each edge of each mounting board 11 is composed of three protrusions 11T and three recessions 11B as shown in FIG. 2, for example, of those three recessions 11B, two engage with protrusions 11T of another mounting board 11 and the other engages with a protrusion 11T of yet another mounting board 11 (that is, one mounting board 11, at one of its four edges, makes close contact with two other mounting boards 11 at one of their edges each; see the part enclosed by a dash-and-dot line in FIG. 2).

In a design like this where one edge of a mounting board 11 abuts a plurality of mounting boards 11, as shown in FIG. 1, the mounting boards 11 are not in a matrix-form arrangement. In other words, even when the abutting edges of mounting boards 11 do not completely coincide but are displaced along each other, they make close contact with each other. That is, a plurality of mounting boards 11 make close contact with one another in an arrangement other than rectangular. Thus, the mounting board unit 13 can cope with backlight units 49 of various shapes.

As shown in FIG. 5, each LED 21 has an anode (positive electrode) 31 and a cathode (negative electrode) 32. The anode 31 and the cathode 32 connect to connectors 35 via conductors 33 (33A, 33B). Each connector 35 includes three terminals 36 (36B, 36A, 36B) arranged side by side. Of these three terminals 36 arranged side by side, the one 36 at the center is a positive terminal 36A, and those 36 at both ends are negative terminals 36B (the conductor that electrically connects between the anode 31 and the positive terminal 36A is identified by the reference sign 33A, and the conductor that electrically connects between the cathode 32 and the negative terminals 36B is identified by the reference sign 33B).

The connector 35, which thus includes the positive terminal 36A electrically conducting to the anode 31 of the LED 21 and the negative terminals 36B electrically conducting to the cathode 32 of the LED 21, is attached at each edge of each mounting board 11 having one of different shapes, so that the connectors 35 on adjoining mounting boards 11 electrically conduct to each other. Specifically, in a case where a plurality of mounting boards 11 are arranged in close contact with one another in a lattice-form arrangement as shown in FIG. 4, connectors 35 are arranged in such a way that abutting connectors 35 (hence, terminals of each of the same, positive and negative, polarities) abut each other to achieve both physical and electrical connection.

With this design, when a positive and a negative power terminal 71A and 71B of an electric power supply 71 are electrically connected to the positive terminal 36A and the negative terminals 36B, respectively, of the connector 35 via conductors 72, the LEDs 21, now connected in parallel with one another, can receive electric current. Thus, the overall mounting board 11 has a simpler circuit configuration for current supply. With the design shown in FIG. 4, irrespective of which connector 35 the electric power supply 71 is connected to, all the LEDs 21 are supplied with electric current.

On the other hand, with the design shown in FIG. 2, each group of mounting boards 11 among which abutting edges completely coincide requires an electric power supply 71.

### [Modifications and Variations]

The present invention is in no way limited by the embodiment specifically described above, and many modifications and variations are possible without departing from the spirit of the invention.

For example, although the above description deals with a case where the mounting boards 11 have undulated edges as an example of wavy edges, this is not meant as any limitation. For example, as shown in FIG. 6, the mounting boards 11 may have serrated (saw-tooth-shaped) edges as wavy edges.

Although the above description deals with a case where one mounting board 11 has one LED 21 mounted on it, this is not meant as any limitation. For example, one mounting board 11 has a plurality of LEDs mounted on it. Using mounting boards 11 each having a polarity of LEDs 21 mounted on them makes it possible to vary the density (of distribution) of LEDs 21 in the backlight unit 49 as necessary.

For example, since people's visual attention tends to concentrate at the center of a liquid crystal display panel, the luminance there is often raised compared with elsewhere on the liquid crystal display panel. In such cases, using mounting boards 11 each having a plurality of LEDs 21 mounted on them makes it possible to arrange the LEDs 21 more densely near the center of the mounting board unit 13 corresponding to the center of a liquid crystal display panel than elsewhere.

Although the above description deals with a case where display devices 69 mounted on buildings are taken up as an example of digital signage, this is not meant as any limitation. For example, display devices 69 mounted on walls inside railroad cars also serve digital signage. Needless to say, the backlight unit 49 described above finds applications not only in digital signage but also in liquid crystal display devices for home use.

There is no particular limitation on the emission color of the LEDs 21. For example, LEDs 21 emitting red light, LEDs 21 emitting green light, and LEDs 21 emitting blue light may be used in combination in the backlight unit 49 so that the light from them mixes to produce white light, or to produce light of any other color (light of any single or mixed color). That is, the backlight unit 49 may be a full-color illumination device (light source device). Needless to say, all the LEDs 21 may be LEDs 21 that emit white light.

It is preferable that the LEDs 21 be supplied with electric power adequately, that is, neither excessively nor insufficiently. To that end, the LEDs 21 are connected to, for example, an unillustrated supply electric power adjustment device (power adjustor) incorporated in the backlight unit 49.

### INDUSTRIAL APPLICABILITY

The present invention finds applications in a variety of display devices such as television monitors, digital signs, etc.

### LIST OF REFERENCE SIGNS

11 mounting board

11T protrusion at an wavy edge of a mounting board

11B recession at an wavy edge of a mounting board

13 mounting board unit

21 LED (point light source, light emitting element)

31 anode (positive electrode)

32 cathode (negative electrode)

33 conductor

35 connector

36 terminal

36A positive terminal

36B negative terminal

43 diffusive plate (diffusive member)

44 luminance enhancing film (luminance enhancing member)

49 backlight unit

69 display device

71 electric power supply

72 conductor

1. An illumination device, comprising a light source and a plurality of mounting boards on which the light source is arranged, wherein
the plurality of mounting boards are arranged in close contact with one another,
the mounting boards have edges that are wavy as by being undulated or serrated,
abutting ones of the edges have wavy contours composed of protrusions and recessions that are in a meshing relationship, and
the protrusions at the edges occur at constant intervals and the recessions at the edges occur at constant intervals.

2. The illumination device according to claim 1, wherein
The mounting boards are, at the edges thereof, fitted with connectors each including a positive terminal that electrically conducts to a positive electrode of the light source and a negative terminal that electrically conducts to a negative electrode of the light source, and
between the connectors of adjoining ones of the mounting boards, the terminals of each of same polarities electrically conduct to each other.

3. The illumination device according to claim 1, wherein
the light source comprises a light emitting element.

4. The illumination device according to claim 3, wherein
the light emitting element comprises a plurality of light emitting elements that emit red, green, and blue light respectively.

5. The illumination device according to claim 3, wherein
the light emitting element comprises a plurality of light emitting elements that emit white light.

6. The illumination device according to claim 1, further comprising a power adjustor which adjusts an amount of electric power supplied to the light source.

7. The illumination device according to claim 1, further comprising a diffusive member which diffuses light from the light source.

8. The illumination device according to claim 1, further comprising a luminance enhancing member which enhances luminance while transmitting light from the light source.

9. A display device, comprising:
the illumination device according to claim 1; and
a display panel which receives light from the illumination device.

10. The display device according to claim 9, wherein
the display panel is a liquid crystal display panel.
